(19) United States
(12) Patent Application Publication
(10) Pub. No.: US 2018/0026805 A1
(43) Pub. Date: Jan. 25, 2018

(54) METHOD AND SYSTEM FOR SCHEDULING A COMMUNICATION SESSION

(71) Applicant: Lam Trong Ho, Austin, TX (US)

(72) Inventor: Lam Trong Ho, Austin, TX (US)

(21) Appl. No.: 15/652,688

(22) Filed: Jul. 18, 2017

Related U.S. Application Data
(60) Provisional application No. 62/364,294, filed on Jul. 19, 2016.

(51) Int. Cl. H04L 12/18; H04L 29/08

(52) U.S. Cl. CPC H04L 12/1818; H04L 67/20

(57) ABSTRACT

Provided is method and system for synchronizing a communication appointment. The method includes synchronizing to a first user calendar. The first user calendar includes one or more identified available time slots. In some embodiments, a request for a communication appointment between a first user and the second user is received (e.g., from a second user). The request for the communication appointment includes a requested appointment time. The request for the communication appointment is processed, where the processing the request includes determining whether the requested appointment time includes at least one of the one or more identified available time slots. Based on a determination that the requested appointment time does include at least one of the one or more identified available time slots, the communication appointment between the first user and the second user is synchronized.

### PRIORITY DATA

This application claims the benefit of U.S. Provisional Application No. 62/364,294, filed Jul. 19, 2016, the entirety of which is incorporated by reference herein.

### BACKGROUND

Conventional methods of scheduling a voice or video communication session between two or more parties can be quite cumbersome. The first issue is platform and operating system incompatibility. For example, a native video call such as Facetime only works within the iOS platform. Moreover, there are 3 major operating systems in the market today: iOS, Android, and Windows which operate on a smart-phone, tablet, personal computer, or other type of electronic device. To establish a communication channel such as a voice or video call between those platforms running on different operating systems, a third-party communication application is required. Examples of popular third-party communication applications that support voice calls, video calls, and instant-messaging are Skype, Viber, Facebook Messenger, Whatsapp and a few others. A common issue with these third-party applications is that they require the installation of the same application on the transmitting end as well as the receiving end (e.g., of the communication channel). This creates a major obstacle when trying to establish communication between two or more people who do not know each other and/or do not know if the other parties have the same application installed on their device or not. That leads to the second issue which is scheduling. If one party (e.g., a requestor) wants to setup an appointment for a voice and/or video call with another party (e.g., a receiver) anywhere in the world, there is no simple way to do it. He/she must use another means of communication to setup an appointment (e.g., an email request), and the individual (e.g., the requestor) has to check what communication application the other party (e.g., the receiver) or parties are using. If one or more of the other parties are not using the same application as the initiator (e.g., the requestor), then he/she has to instruct the one or more other parties (e.g., the receiver) to download, install, and register the application that is the same as what the initiator (e.g., the requestor) has installed on his/her device. When the time for the scheduled-session arrives, a reminder message will likely display (e.g., on the requestor's device), but such a reminder has no information regarding how to connect with the other parties (e.g., the receiver). The initiator (e.g., the requestor) has to find the contact information of the other parties (e.g., the receiver) and make a call. If there are multiple parties, that task would even be more difficult. As one example, existing Skype and Microsoft applications do not solve this issue entirely. For instance, there is not a way to schedule a video/voice call appointment without making sure the other parties also have Skype and Outlook installed on their device(s). These issues make the application of voice and video-communication for everyone on the internet, and especially for those engaged in e-commerce, very difficult since it involves too many compatibility issues multiplied by the number of different platform and operating systems that an initiator (e.g., a requestor) has to accommodate, making it impossible to scale and support. For example, if a seller on eBay would like to support any buyer on eBay to make a video call with him, given the volumes of buyers on such a sizable online marketplace, it would be impossible for the seller to support them using existing methods of voice and/or video communication.

### BRIEF DESCRIPTION OF THE DRAWINGS

For a more detailed description of the various embodiments, the detailed written description can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A illustrates a process for a Receiver to setup an account, in accordance with some embodiments;

FIG. 1B illustrates a process for a Requestor to make a communication appointment with a Receiver, in accordance with some embodiments;

FIG. 2 illustrates a block diagram of a system, in accordance with embodiments of the invention;

FIG. 3 shows a flow-diagram illustrating a general process flow, implemented within the system, according to some embodiments;

FIG. 4 illustrates an exemplary routine for handling a Communication Request;

FIG. 5 illustrates an exemplary subroutine for handling a registration process, according to some embodiments; and

FIG. 6 illustrates an exemplary subroutine for handling establishment of communication.

### DETAILED DESCRIPTION

The following discussion is directed to various embodiments which provide a method and system for scheduling a communication session. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment. Also, various elements depicted herein are illustrated with particular dimensions, locations, and/or orientations relative to one another for purposes of simplicity and ease of understanding, and actual dimensions, locations, and/or orientations of the various elements may differ substantially from that illustrated herein.

Certain terms are used throughout the following description and claims to refer to particular system components. As one skilled in the art will appreciate, various companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

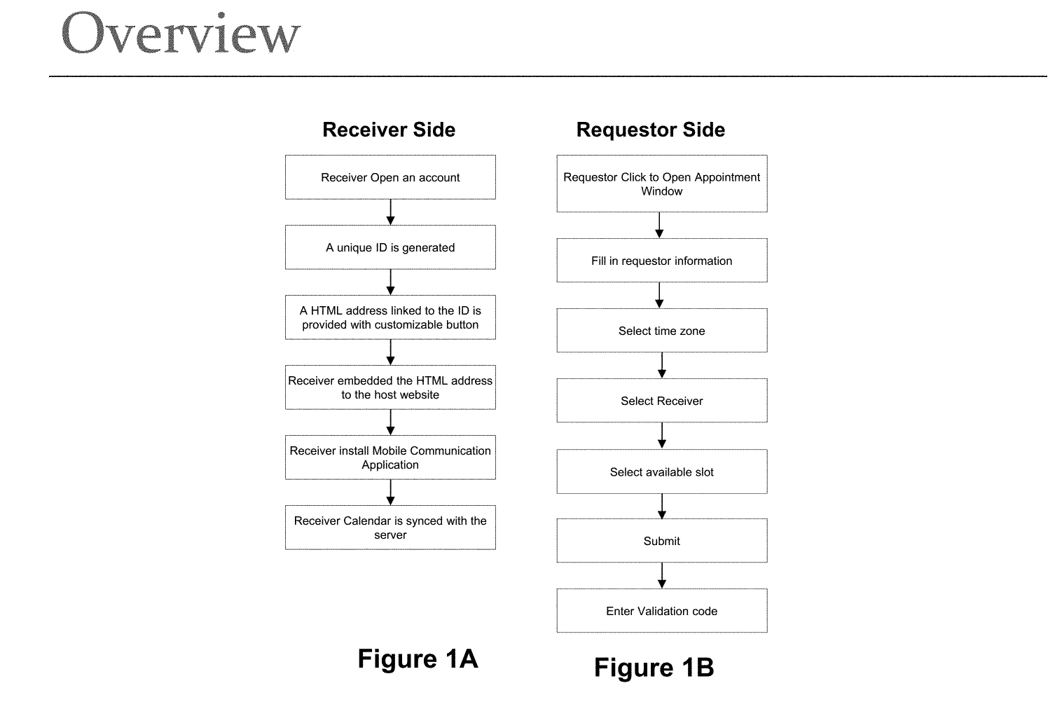

With reference now to the figures, FIG. 1A illustrates the process for a Receiver to setup an account (e.g., on a system including a server that includes hardware and/or software configured to implement the various embodiments disclosed herein), which may thereby generate a unique ID. In some embodiments, the unique ID may be used to create a unique HTML address as well as a customizable HTML button (e.g., an “appointment button”) provided to the Receiver, for example, to be embedded into a Receiver website or into a website used by the Receiver. In some cases, the server will send a link to the Receiver with details and/or instructions regarding installation of a Mobile Communication Application onto a Receiver electronic device (e.g., a smart-phone, tablet, personal computer, or other type of electronic device). In some embodiments, the Mobile Communication Application, installed on the Receiver electronic device, communicates with the server to provide one or more features of the various embodiments described herein. In various examples, after the installation of the Mobile Communication Application onto the Receiver electronic device is completed, a Receiver calendar will be synced with the server. In various embodiments, the Receiver calendar will include information regarding meetings, appointments, vacations/holidays, etc., and will generally provide dates and times at which the Receiver is available to engage in a voice and/or video communication session with a Requestor.

FIG. 1B illustrates the process for a Requestor to request, and ultimately make, a communication appointment with a Receiver. As used herein, the phrase “communication appointment” is used to describe an appointed time at which the Requestor and the Receiver have agreed to engage in a voice and/or video communication session (e.g., by way of a respective electronic device). By way of example, the Requestor may begin by clicking on an appointment button (e.g., embedded into a Receiver website that provides a web-based system interface), thereby causing a window to pop-up on a user interface of a user electronic device on which the Receiver website is displayed. In some examples, clicking the appointment button causes the system to generate the pop-up window. Illustratively, the Requestor may then enter his/her information (e.g., into fields within the pop-up window), including such information as a Requestor name and mobile phone number. In some embodiments, the Requestor then selects his/her time-zone. Thereafter, by way of example, the Requestor may select the Receiver with whom he/she wants to setup an appointment. In various embodiments, the system will load the Receiver's calendar (e.g., for viewing by the Requestor via the pop-up window) and the Requestor can select an available time-slot. Upon selecting the time-slot and clicking a submit button, the Requestor may then be prompted to enter a validation code sent to the Requestor's electronic device (e.g., phone or other device) via SMS message. If the validation code is valid (e.g., the code is authenticated by the system), the process is completed and the system will proceed further. If not, the Requestor may have an option of requesting that the system send another confirmation code for validation. By way of example, the validation process is used to ensure the Requestor has entered a valid phone number. It is also noted that in some cases the Mobile Communication Application may be installed on the Requestor electronic device (e.g., prior to making an appointment), where the Requestor electronic device communicates with the server to provide one or more features of the various embodiments described herein. Thus, in at least some embodiments, the communication appointment can be requested and made directly with the Mobile Communication Application executing on the Requestor electronic device.

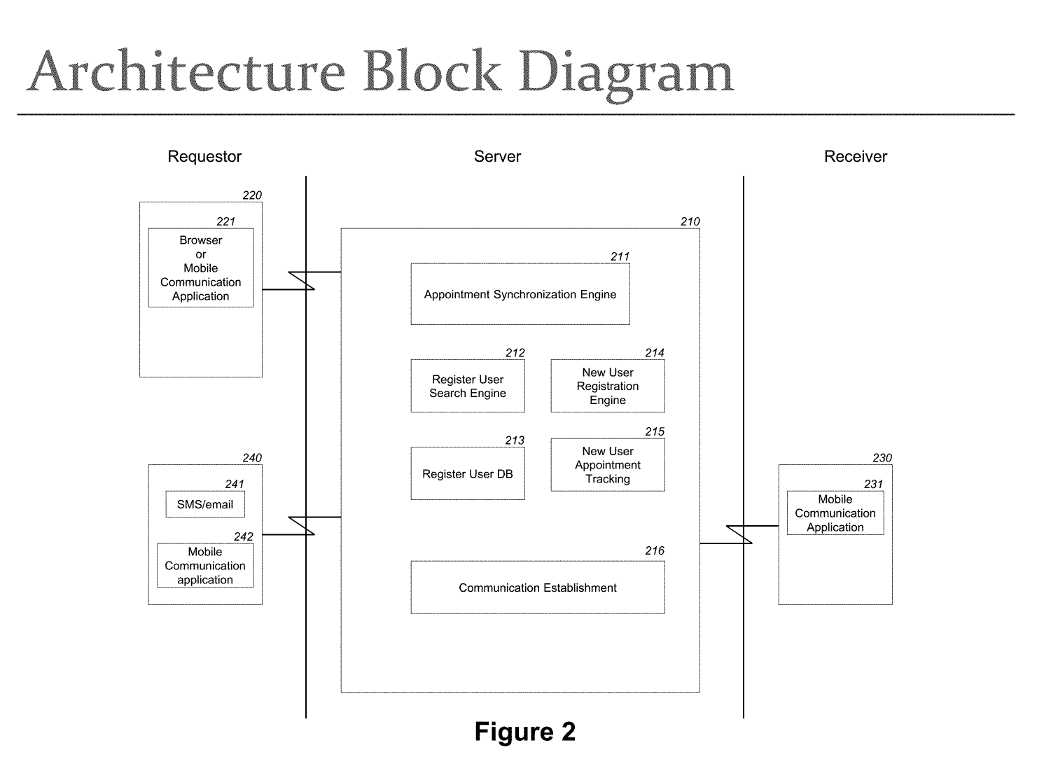

FIG. 2 illustrates a block diagram of a system used to implement various embodiments of the present disclosure. The system includes a server 210 that further includes an Appointment Synchronization Engine 211 which is responsible for synchronizing the appointment between the Requestor and the Receiver. In various examples, the server may also include a Registered-user Search Engine 212 that can search a Registered-User Database 213 for the existence of an account based on the information the Requestor provided (e.g., via the pop-up window, as described above). If the Requestor is not found in the database, a New User Registration Engine 214 may provide information to the Requestor for downloading and registering. Upon a successful completion of the registration process, a New User Appointment Tracking 215 function will locate the Requestor appointment (e.g., which may include the requested communication appointment) and signal the Appointment Synchronization Engine 211 to synchronize the scheduled event. The system may also include a Requestor computer 220 and a browser 221, which provides the web-based system interface, and where the appointment request originated. In some embodiments, the system may also include a Requestor mobile device 240 which includes SMS/email 241 functionality, a Mobile Communication Application 242 (e.g., which is the mobile application described above, used to carry out one or more aspects of the embodiment as described herein), as well as any number of a variety of other applications as known in the art. In various embodiments, the server may also synchronize the appointment with a Receiver mobile device 230 and a Mobile Communication Application 231 executing on the Receiver mobile device 230.

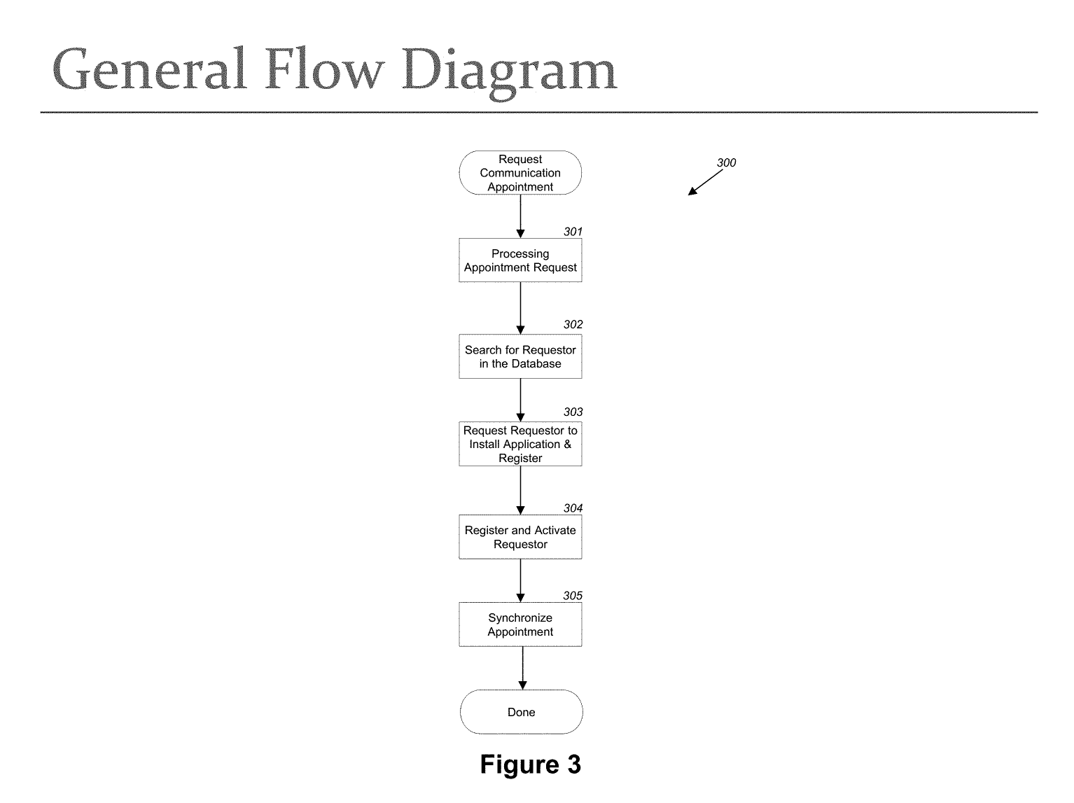

FIG. 3 provides a flow-diagram illustrating a general process flow 300, implemented within the system, according to some embodiments. By way of example, the general process flow 300 involves the processing of the appointment request by checking for an available time slot 301 as well as searching for the Requestor in the database 302. If the Requestor is not found in the database, the system will request that the Requestor install the Mobile Communication Application and register 303. In various embodiments and when the Mobile Communication Application is downloaded, the registering process is handled at the Register and Activate Requestor step 304. Upon the successful completion of step 304, the system will synchronize the requested Appointment between the Requestor and the Receiver Mobile Communication Application. In some embodiments, “synchronizing an appointment” may be used to describe confirming that a requested time-slot is available, and once confirmed, adding the appointment as a scheduled appointment to each of the Requestor's and the Receiver's calendars.

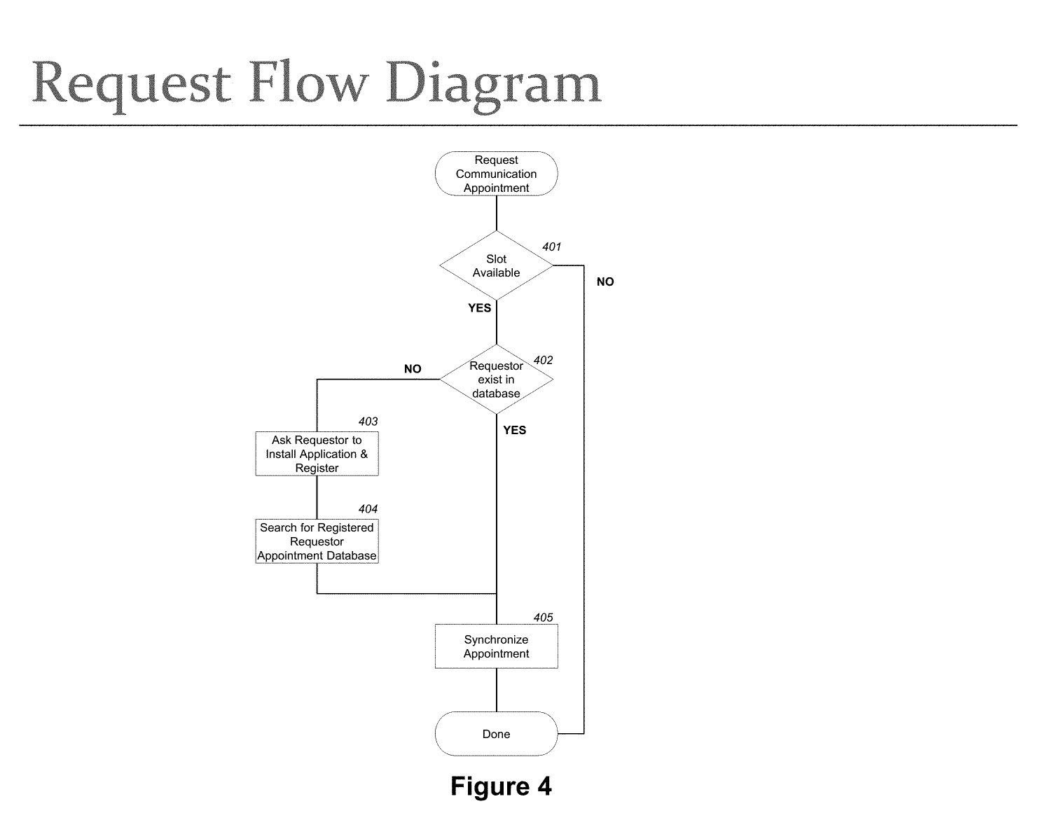

FIG. 4 illustrates an exemplary routine for handling a Communication Request. When a Communication Appointment Request is made, the system will check the availability of the requested time-slot. If not available, the system will terminate and ask the Requestor to select another slot. If the slot is available, the system will proceed to check if the Requestor is a registered user. If yes, the system will proceed with the Synchronization of the Appointment. If the Requestor is not a registered user, the system will ask the Requestor to install the Mobile Communication Application and Register. Once registered, the system will check the newly registered users against a database that contains the non-registered-user appointment requests and trigger a Synchronization of the Appointment.

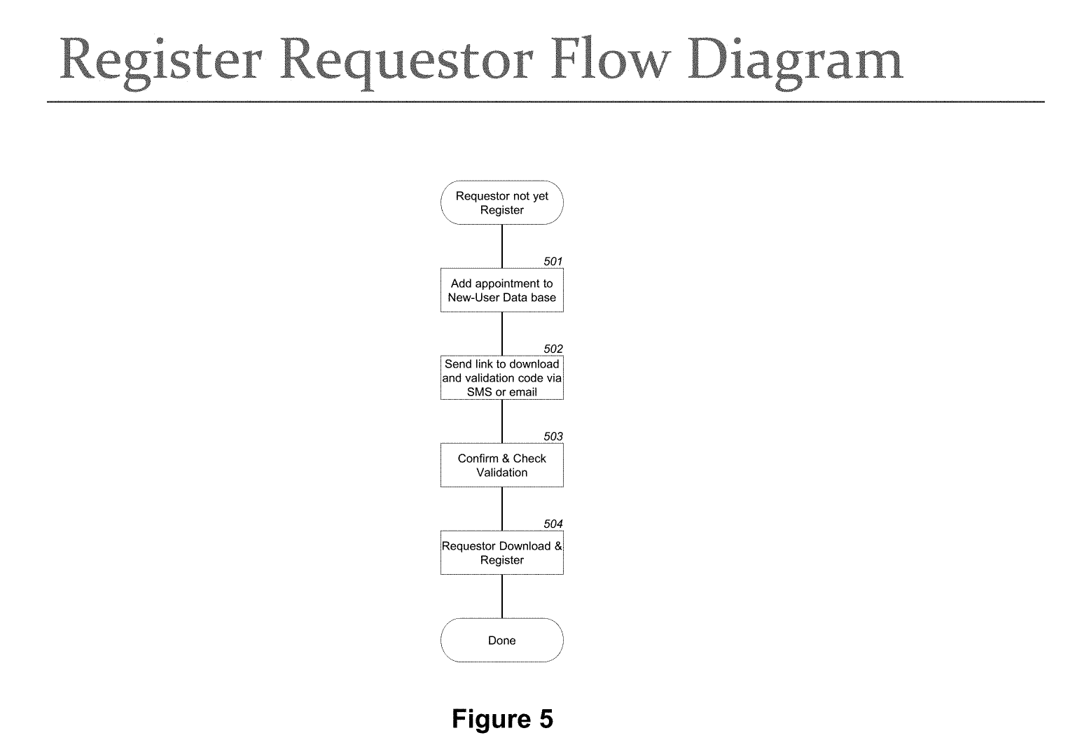

FIG. 5 illustrates the subroutine that handles the registration if the Requestor is not in the system (e.g., not a registered user). The first step involves adding the appointment (e.g., the requested appointment) together with the Requestor information to the database. The system may then send a link to download (e.g., the Mobile Communications Application) and a validation code to the Requestor via SMS message. The Requestor may then confirm by entering the validation code, as previously described. If successful, and in some embodiments, the system will wait for the Requestor to download and register the Mobile Communication Application.

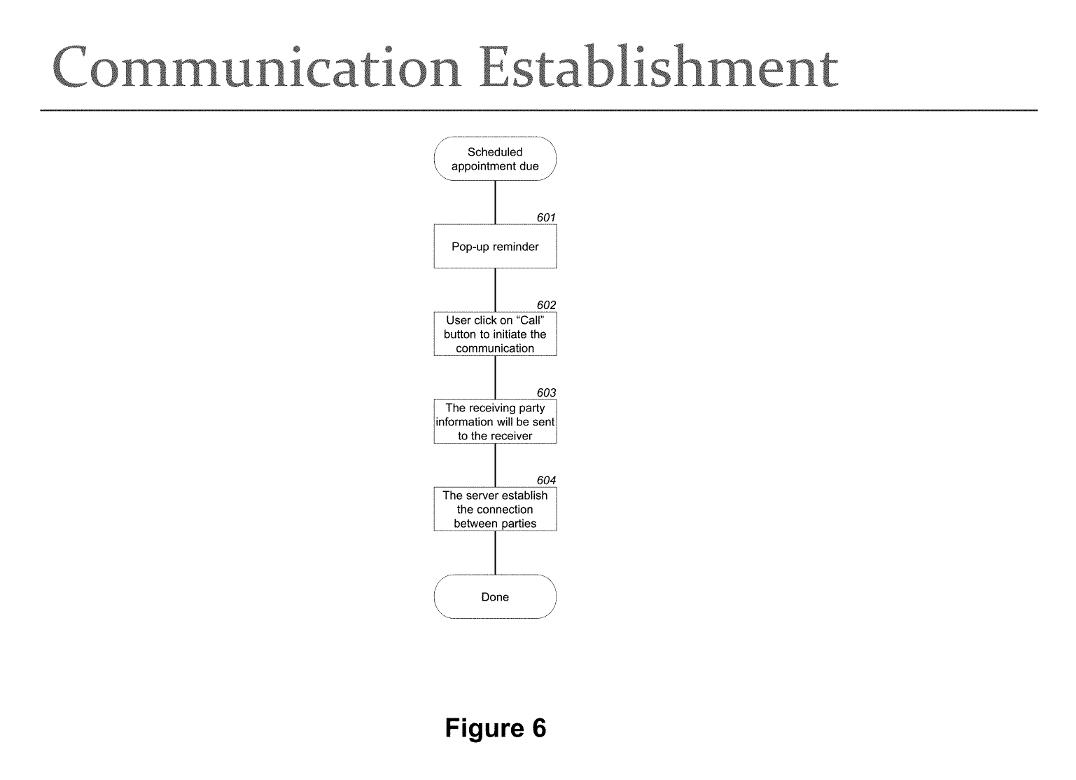

FIG. 6 illustrates the subroutine that handles the communication establishment. When the scheduled appointment is due (e.g., when the previously scheduled time arrives), a pop-up reminder may be displayed (e.g., via a user interface of a Requestor and/or Receiver device), where the pop-up reminder may include a “call” button. Thus, either user (e.g., the Requestor or the Receiver) can click on the “call” button to initiate either a video or voice call within the Mobile Communication Application. The Mobile Communication Application may then send the receiving party information to the server and the server will establish the communication channel between parties (e.g., the Receiver and the Requestor), thereby allowing the voice and/or video communication to be carried out.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

Furthermore, while the above discussion is meant to be illustrative of the principles and various embodiments of the present invention, numerous variations and modifications will become apparent to those skilled in the art once the above disclosure is fully appreciated. It is intended that the following claims be interpreted to embrace all such variations and modifications.

What is claimed is:

1. A method, comprising:
synchronizing to a first user calendar, wherein the first user calendar includes one or more identified available time slots;
receiving, from a second user, a request for a communication appointment between a first user and the second user, wherein the request for the communication appointment includes a requested appointment time;
processing the request for the communication appointment, wherein the processing the request includes determining whether the requested appointment time includes at least one of the one or more identified available time slots;
based on a determination that the requested appointment time does include at least one of the one or more identified available time slots, synchronizing the communication appointment between the first user and the second user.

2. The method of claim 1, wherein the second user is a requesting user, and wherein the processing the request further includes searching for the requesting user in a registered user database.

3. The method of claim 2, further comprising:
determining that the requesting user is not in the registered user database;
prompting the requesting user to become a registered user; and
updating the registered user database to include the requesting user.

4. The method of claim 1, further comprising:
sending a validation code to the second user; and
checking the validation code to determine that a phone number associated with the second user is a valid phone number.

5. The method of claim 1, wherein the first user is a receiving user.
